(19) United States
(12) Patent Application Publication
(10) Pub. No.: US 2003/0097372 A1
(43) Pub. Date: May 22, 2003

(54) Method and system for managing electrical schematic data

(76) Inventors: Cynthia Bertini, Canton, MI (US); John Nguyen, Ypsilanti, MI (US)

Correspondence Address: FORD GLOBAL TECHNOLOGIES, INC, SUITE 600 - PARKLANE TOWERS EAST, ONE PARKLANE BLVD., DEARBORN, MI, 48126, US

(21) Appl. No.: 10/065,801

(22) Filed: Nov. 20, 2002

Related U.S. Application Data
(60) Provisional application No. 60/333,965, filed on Nov. 20, 2001.

(51) Int. Cl. G06F 7/00

(52) U.S. Cl. 707/104.1

(57) ABSTRACT

A method and system for managing electrical schematic data has been disclosed. The method includes the step of generating three separate schematics for an electrical part, a logical schematic, a layout schematic, and a physical schematic. These schematics are then stored together in part master file such that they may not be independently retrieved from a computer network. A computer utility manages the master file such that only one user may modify the part master file at a time. Additionally, the computer utility tracks all of the modifications to the part master file and saves all versions and revisions. If a change has been made to a part master file that would affect a second part master file, users will automatically be notified by the computer utility that a change has been made.

### CROSS REFERENCE TO RELATED APPLICATIONS

This application claims priority to Provisional Application No. 60/333,965, which was filed on Nov. 20, 2001 and is incorporated herein by reference.

### BACKGROUND OF INVENTION

1. Technical Field

The present invention relates generally to a method and system for storing and managing electrical schematics of a system, and more particularly, to a method and system for controlling the modification of electrical schematics of a product or part of a product.

2. Background of the Invention

Complex systems are usually composed of many component parts. Each of these component parts may be separately designed. For example, automobile manufacturers must design thousands of individual components that are utilized to assemble a complete vehicle. Often different individuals or groups are responsible for designing each different part or sub-assembly of the finished product. Additionally, some manufacturers rely on third party suppliers to design and manufacture component parts that will be used in the final product. The design of these sub-assemblies and component parts often depend on the design of other component parts or sub-assemblies. For example, the physical design of a vehicle's rear bumper depends on the physical design of the vehicle's frame, rear panels, trunk, etc., not to mention the fasteners and other connectors utilized in the design. A small modification in the design of one component part may effect the design of the entire product, or at least the design of other component parts.

This problem is exacerbated for products with complex electrical systems, e.g., an automobile. An automobile has a large number of separate electrical sub-assemblies, e.g., interior lighting, exterior lighting, safety sensors, entertainment devices, and power windows and seats, to just name a few. Each of these subassemblies is separate, and yet must all be interconnected to the vehicle's main power distribution system and, therefore, each other.

Designs of component parts, sub-assemblies, assemblies, etc. are often memorialized in a schematic or set of schematics. Each part may have multiple schematics, for example an electrical part may have a logical schematic, a physical schematic, and a layout schematic. Additionally, each of these parts may be a part of a larger system schematic. There are often many layers of schematics for each sub-assembly, each with a different degree of complexity and detail. When designers modify the design of electrical sub-assemblies throughout the design process, a change to the design of an electrical sub-assembly may not be communicated to all other effected designers. Furthermore, different designers may make incompatible design changes in common or shared sub-assemblies. Each of these scenarios results in different copies of the same schematic that can be further modified independently from each other. This creates confusion and inefficiency in the design process.

It would therefore be desirable to provide a method and system for storing and managing electrical schematics of a product or sub-assembly of a product and, more particularly, a method and system for controlling the modification of electrical schematics of a product or sub-assembly of a product.

### SUMMARY OF INVENTION

The present invention provides a system and method for managing electrical schematic data.

In one aspect of the invention, a method for managing electrical schematic data is disclosed. This method comprises the steps of creating a logical system schematic, a physical system schematic, and a system layout schematic for an assembly part. This method further comprises the step of associating the logical system schematic, the physical system schematic and the system layout schematic together to form a part master file. The method also comprises the step of storing the part master file on a computer network. Additionally, the method comprises providing access to the part master file to a plurality of user locations. The method further comprises the step of controlling modification of the part master file by allowing only one of the plurality of user locations to modify the part master file at a time.

In a further aspect of the invention, a system for managing electrical schematic data is disclosed. The system comprises a computer, at least one computer aided engineering software program, a computer schematic utility, and a computer network. The computer aided engineering (CAE) software program is capable of creating a logical system schematic, a physical system schematic, and a system layout schematic for an assembly based on an input into the computer from a user. The computer schematic management utility is capable of associating the logical system schematic, the physical system schematic and the system layout schematic together to form a part master file. The computer network comprises the computer and a plurality of user locations, and is capable of storing the part master file and providing access to the part master file to the plurality of user locations. Furthermore, the computer schematic management utility controls modification of the part master file stored on the computer network.

One advantage of the invention is that it ensures that only one master file of the schematics for an assembly exists at a time. Another advantage of the invention is that a complete record of all modifications to the part master file, as well as the individual or group who modified the file, is stored so that the record may be used to troubleshoot design problems. Another advantage of the invention is that the part master file is available to all users of the computer network. Another advantage of the invention is that interested designers will be notified of a modification to the part master plan automatically.

Other advantages and features of the present invention will become apparent when viewed in light of the detailed description of the preferred embodiment when taken in conjunction with the attached drawings and appended claims.

### BRIEF DESCRIPTION OF DRAWINGS

FIG. 1 is a representation of a part master file according to an embodiment of the present invention.

FIG. 2 is a diagrammatic view of a system for use in conjunction with a method for managing electrical schematic data according to an embodiment of the present invention.

FIG. 3 is a diagrammatic view of the schematic design process for a part according to an embodiment of the present invention.

### DETAILED DESCRIPTION OF THE PREFERRED EMBODIMENT

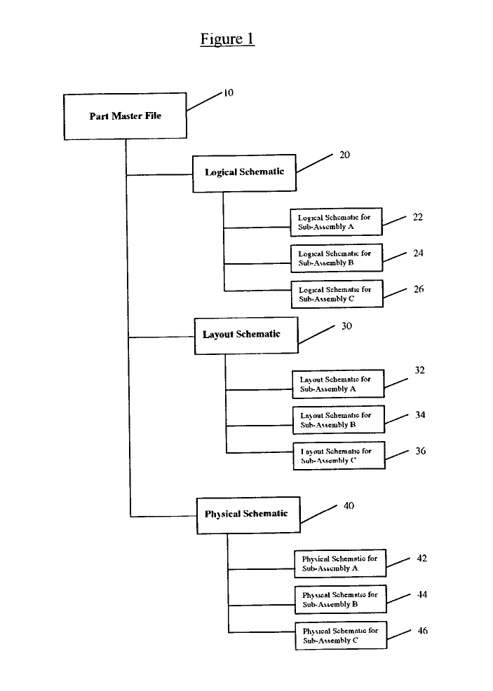

Referring now to FIG. 1, an embodiment of a part master file according to the present invention is disclosed. The part in this embodiment comprises three sub-assemblies: sub-assembly A, sub-assembly B, and sub-assembly C. The part master file 10 comprises a logical schematic 20, a layout schematic 30, and a physical schematic 40 of the part or assembly. A logical schematic 20 is a schematic diagram comprising the logical layout of the electrical system that it describes. The logical layout is one that fully describes the electrical relationship of the circuit, but does not necessarily describe the electrical components used nor the physical positioning of those components. A logical schematic 20 is usually the first schematic to be designed. A layout schematic is a schematic diagram that shows the electrical components used in the design and the connections between them, i.e., the layout, but does not describe the exact physical positioning of the components. A physical schematic is a schematic diagram that fully describes the electrical components used and their connections, showing the exact physical positioning of the components.

In FIG. 1, the logical schematic 20 further comprises a logical schematic for sub-assembly A 22, a logical schematic for sub-assembly B 24, and a logical schematic C 26. Each of the logical schematics for the sub-assemblies describes the logical layout of its sub-assembly. Similarly, the layout schematic 30 further comprises a layout schematic for sub-assembly A 32, a layout schematic for sub-assembly B 34, and a layout schematic C 36, and the physical schematic 40 further comprises a physical schematic for sub-assembly A 42, a physical schematic for sub-assembly B 44, and a physical schematic C 46. Having separate schematics for sub-assemblies is common for complex assemblies, especially in situations where different individuals or groups are responsible for the design of the different sub-assemblies.

The part master file 10 may comprise a directory in computer memory in which each of these schematics is stored. The part master file 10 is preferably stored on a computer network so that it is available to many users. Additionally, the network could be organized such that only certain users could perform certain tasks related to the part master file, for example, some users could be set up such that they could only view the part master file or only modify a specific portion of the part master file.

The part master file 10 is preferably generated by a computer utility. The computer utility associates the logical schematic 20, the layout schematic 30, and the physical schematic 40 of the assembly together. This may be accomplished, for example, by storing these schematics with a common file name format. For example, the file name format may include a code that indicates an assembly number, the type of schematic, i.e., logical, physical, or layout, any associated sub-assemblies or super-assemblies, and a revision and version number. In this example, the computer utility would search for common information in the file names of the schematics and use this common information to associate the related schematics together. Other methods of associating schematics together could also be used, e.g., requiring a user to associate all related schematics manually.

Once stored, the part master file 10 (or any of its components) must be checked out in order to be modified. Preferably, a user checks out the part master file 10 by accessing the computer network and retrieving the file 10. The user would then use whatever computer programs were used to generate the schematics to modify them. For purposes of this invention, it is irrelevant what Computer Aided Design (CAD) or Computer Aided Engineering (CAE) tools are used to generate the schematics because the schematic information is stored in the schematics' native format(s). The method and system of this invention create the relationships between the schematics independent of the tool used to generate the schematics. When the part master file 10 is checked out, it cannot be checked out by another user. Preferably, the part master file 10 could be viewed by another user, but not modified, i.e., it could be viewed as a read-only file. This ensures that only one part master file 10 exists for the assembly. The user would then check in the modified part master file 10 and it would be stored as a new version. Preferably the system would store all previous versions of the part master file 10 so that a record is made of all modifications. Additionally, the date of the modification and the user who checked out the part master file 10 could also be stored to complete the record.

This invention further provides for the integrity of a part master file by storing only one instance of each of the schematics. For example, sub-assembly A and its associated schematics 22, 24, and 26 may also be relevant to a part master file of a second assembly of the product. This invention will store a pointer in the part master file of the second assembly instead of storing the associated schematics a second time. This pointer will reference, or point, to the original schematics 22, 24, and 26 in the first part master file so that consistency is maintained. In this manner, the invention ensures that only one set of schematics is stored for each assembly or sub-assembly, no matter how many times the assembly or sub-assembly is referenced in the part master file or different part master files.

This invention further provides for a notice to be sent to certain users when a modification is made to the part master file. Users could subscribe to a list of users who want to be notified of any modification to an assembly or sub-assembly schematic. The computer network would notify the users on the associated list of subscribers when a modified part master file is checked back into the system, e.g., by sending an e-mail notice. By doing so, the invention ensures that all interested users are notified when a change is made to a schematic that may affect the design on which he or she is working.

Preferably, the part master file 10 would further comprise an image file of the schematics. This image file would preferably be stored in a commonly available format, e.g., a PDF file, so that the schematics could be viewed by users without the CAE or CAD tools used to generate the schematics.

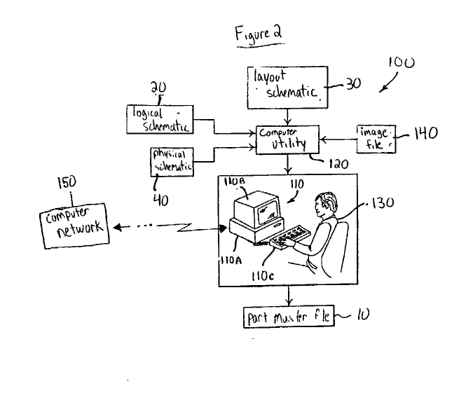

Referring now to FIG. 2, a diagrammatic view of a system for use in conjunction with a method according to the present invention is disclosed. The system 100 includes a computer system 110 having a processor, a controller, and a memory shown at 110A to process information relevant to the method and system for managing electrical schematic data. The computer system 110 includes a display device 110B, such as a video terminal, to display information related to the method. The computer system is connected to a computer network 150.

In this example, information is displayed on the video terminal 110B in a series of screens. Selection and control of the information within a screen can be achieved by the user 130 via a user interactive device 110C, such as a keyboard or a mouse. A user 130 inputs information into the computer system 110 when prompted to do so. The information preferably represents the logical schematic 20, layout schematic 30, physical schematic 40, and an image file 140. Preferably, a computer utility 120 for generating the part master file 10 from this information is already stored in the memory of the computer of the computer system 110. The computer utility 120 utilizes the information input via user interactive device 110C by the user 130 to generate the part master file 10 by the method described above. This part master file 10 is preferably stored in on the computer network 150, but may also be output via the display device 110B or by another output device, e.g., a computer printer.

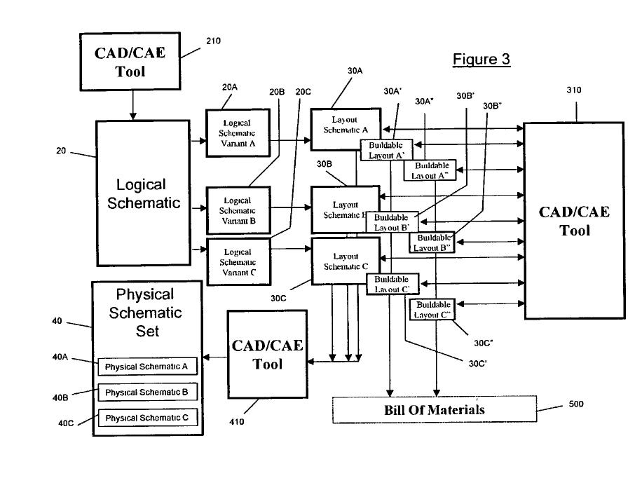

Referring now to FIG. 3, a diagrammatic view of the schematic design process for a part is shown. A logical schematic 20 is created by a designer of the electrical part to describe the appropriate operation of the circuit. The logical schematic 20 is usually composed with the use of a CAD or CAE tool 210. In this example, three variants of the logical schematic 20 are composed, 20A, 20B, and 20C. Logical schematic 20A, logical schematic 20B, and logical schematic 20C are different variations on the design of the part, each with a different level of complexity.

Logical schematic 20A, logical schematic 20B, and logical schematic 20C are then used to generate layout schematic 30, comprising layout schematic A, layout schematic 30B, and layout schematic 30C, with CAD/CAE tool 310. In this example, two different buildable layouts are composed for each layout schematic, each buildable layout using, for example, different component parts. That is, layout schematic 30A is used to generate buildable layout 30A′ and buildable layout 30A″. Buildable layout 30A′, buildable layout 30A″, buildable layout 30B′, buildable layout 30B″, buildable layout 30C′, and buildable layout 30C″ are preferably used to generate a bill of materials 500 for each buildable layout.

Layout schematic A 30A, layout schematic B 30B, and layout schematic C 30C are then used to generate the physical schematic 40, comprising physical schematic 40A, physical schematic 40B, and physical schematic 40C, with CAD/CAE tool 410. CAD/CAE tool 210, CAD/CAE tool 310, and CAD/CAE tool 410 may be the same or different tools. Once the logical schematic 20, layout schematic 30, and physical schematic 40 are complete, they are associated together according to the method describe above. Logical schematic 20, layout schematic 30, and physical schematic 40 are preferably associated by storing all of them together into one file, i.e., the part master file, on the computer network. Once associated, the individual schematics may not be checked out from the network independently from each other.

While particular embodiments of the invention have been shown and described, numerous variations and alternate embodiments will occur to those skilled in the art. Accordingly, it is intended that the invention be limited only in terms of the appended claims.

1. A method for managing electrical schematic data comprising:
creating a logical schematic for a part;
creating a layout schematic for said part;
creating a physical schematic for said part;
associating said logical schematic, said layout schematic and said physical schematic together to form a part master file;
storing said part master file on a computer network;
providing access to said part master file to a plurality of user locations; and
controlling modification of said part master file, whereby said controlling comprises allowing only one of said plurality of user locations to modify said part master file at a time.

2. The method of claim 1, wherein said part master file further comprises a schematic image file based on said logical schematic, said layout schematic, and said physical schematic.

3. The method of claim 1, further comprising the steps of modifying said part master file and tracking a modification to said part master file.

4. The method of claim 3, wherein said tracking comprises storing a revised part master file.

5. The method of claim 3, further comprising the step of notifying an interested user location of said modifying.

6. The method of claim 1, wherein said plurality of user locations comprises at least one remote user location.

7. The method of claim 1, further comprising the step of storing a pointer in said part master file, said pointer being capable of indicating a storage location of said logical schematic, said physical schematic and said layout schematic.

8. The method of claim 1, wherein said associating is accomplished by a computer software program.

9. The method of claim 1, further comprising the steps of creating a second logical schematic for a sub-part, creating a second physical schematic for said sub-part, creating a second layout schematic for said sub-part, associating said second logical schematic, said second physical schematic and said second layout schematic together to form a sub-part master file, and storing said sub-part master file in said part master file.

10. The method of claim 9, further comprising the step of controlling modification of said sub-part master file, allowing only one of said plurality of user locations to modify said sub-part master file at a time.

11. A system for managing electrical schematic data comprising:
a computer;
at least one computer aided engineering (CAE) software program, said at least one CAE software program being capable of creating a logical schematic, a layout schematic, and a physical schematic for a part based on an input into said computer from a user;
a computer schematic management utility, said computer schematic management utility being capable of associating said logical schematic, said layout schematic and said physical schematic together to form a part master file; and
a computer network, said computer network comprising said computer and a plurality of user locations, said computer network being capable of storing said part master file and providing access to said part master file to said plurality of user locations;
whereby said computer schematic management utility controls modification of said part master file stored on said computer network.

12. The system of claim 11, wherein said computer schematic management utility controls modification of said part master file by allowing only one of said plurality of user locations to modify said part master file at a time.

13. The system of claim 11, wherein said part master file further comprises a schematic image file based on said logical schematic, said physical schematic, and said layout schematic.

14. The system of claim 11, wherein said computer schematic management utility is further capable of tracking a modification of said part master file.

15. The system of claim 14, wherein said tracking comprises storing a revised part master file.

16. The system of claim 11, further comprising an interested user list, wherein said computer schematic management utility generates a notification to said interested user list when said part master file is modified.

17. The system of claim 16, wherein said notification comprises an electronic message.

18. The system of claim 11, wherein said plurality of user locations comprises at least one remote user location.

19. A method for managing electrical schematic data comprising:
creating a logical schematic for a part with a first computer aided design tool;
creating a layout schematic for said part based on said logical schematic with a second computer aided design tool;
creating a physical schematic for said part based on said logical schematic and said layout schematic with a third computer aided design tool;
associating said logical schematic, said layout schematic and said physical schematic together to form a part master file, said associating comprising storing said logical schematic, said layout schematic, and said physical schematic in a single file;
storing said part master file on a computer network;
providing access to said part master file to a plurality of user locations; and
controlling modification of said part master file, whereby said controlling comprises allowing only one of said plurality of user locations to modify said part master file at a time.

20. The method of claim 19, wherein said part master file further comprises a schematic image file based on said logical schematic, said layout schematic, and said physical schematic.

21. The method of claim 19, further comprising the steps of modifying said part master file and tracking a modification to said part master file.

22. The method of claim 21, wherein said tracking comprises storing a revised part master file.

23. The method of claim 21, further comprising the step of notifying an interested user location of said modifying.

24. The method of claim 19, wherein said plurality of user locations comprises at least one remote user location.
